(19) United States
(12) Patent Application Publication
(10) Pub. No.: US 2013/0167370 A1
(43) Pub. Date: Jul. 4, 2013

(54) PEN TIP PEENING MACHINE

(71) Applicant: Beifa Group Co., Ltd., Ningbo (CN)

(72) Inventors: Cailiang Dong, Ningbo (CN); Feng Zhu, Ningbo (CN)

(73) Assignee: Beifa Group Co., Ltd., Ningbo (CN)

(21) Appl. No.: 13/728,537

(22) Filed: Dec. 27, 2012

(30) Foreign Application Priority Data
Dec. 31, 2011 (CN) 201110459700.3

(51) Int. Cl. B43K 15/02

(52) U.S. Cl. CPC B43K 15/02
USPC 29/808

(57) ABSTRACT

Disclosed peening machines may include a first disc having grooves on a periphery of the disc, wherein the grooves are configured to hold a first workpiece; a second disc having grooves on a periphery of the disc, wherein the grooves are configured to hold a second workpiece. The first and second discs are coaxially aligned with each other and a groove of the first disc is positioned to be aligned with a groove of the second disc. A first reciprocating push rod is positioned to be aligned with a groove of the first disc, a second reciprocating push rod is positioned to be aligned with a groove of the second disc, and a reciprocating peening needle is positioned perpendicular to the first and second pushrods. The peening machine may assemble metal pen tips to ink guide cores by peening the metal pen tips to the ink guide cores.

### TECHNICAL FIELD

This disclosure relates to peening machines, and in particular, to machines for peening a pen tip to an ink guide core of a pen.

### BACKGROUND

A pen that directly delivers liquid ink (otherwise referred to herein as a direct-liquid-supply pen) is more advanced than other kinds of pens. Such pens are widely used because they are environmentally friendly, have high ink utilization, and good writing characteristics. A direct-liquid-supply pen generally includes a shaft tube, an ink reservoir, and a pen tip assembly. The ink reservoir is provided within the shaft tube and is filled with ink. The pen tip assembly includes a hollow metal pen tip, a pen tip seat, and an ink guide core. The rear end of the metal pen tip is coaxially fitted within the pen tip seat. The front end of the ink guide core is inserted into the hollow metal pen tip, and the rear end of the ink guide core is inserted into the ink reservoir. When manufacturing direct-liquid-supply pens, it is necessary to peen the metal pen tip while the ink guide core is inserted therein in order to fix the metal pen tip and the ink guide core. Conventionally, the peening process is done manually. The dents produced are different in depth, and the connection reliability between the metal pen tip and the ink guide core is adversely affected.

### SUMMARY

Peening involves striking a workpiece, such as a metal pen tip, with sufficient force to create a dent that secures another workpiece. For example, peening machines disclosed herein may be used to secure an ink guide core to a metal pen tip. The disclosed peening machines can have a simple structure, are convenient and reliable to operate, and ensure that the connection between the metal pen tip and the ink guide core is reliable.

At least one embodiment of a peening machine includes a first disc having grooves on a periphery of the disc, wherein the grooves extend axially on the periphery and are configured to hold a first workpiece, and a second disc having grooves on a periphery of the disc, wherein the grooves extend axially on the periphery and are configured to hold a second workpiece. The first and second discs are coaxially aligned with each other, and a groove of the first disc is positioned to be aligned with a groove of the second disc. A first reciprocating push rod is positioned to be aligned with each groove individually of the first disc as the first disc rotates, and a second reciprocating push rod is positioned to be aligned with each groove individually of the second disc as the second disc rotates. The second push rod is coaxially aligned with the first push rod, and a reciprocating peening needle is positioned perpendicular to the first and second pushrods.

At least one embodiment of a peening machine includes a first workpiece in a groove of the first disc, and a second workpiece in a groove of the second disc, wherein the first workpiece fits within the second workpiece, wherein the first push rod is aligned with the first workpiece, and the second push rod is aligned with the second workpiece.

At least one embodiment of a peening machine reciprocates the first push rod to push the first workpiece toward the second workpiece, reciprocates the second push rod to push the second workpiece toward the first workpiece, and reciprocates the peening needle to strike the second workpiece when the first workpiece is within the second workpiece.

At least one embodiment of a peening machine uses an ink guide core as the first workpiece and a pen tip as the second workpiece.

At least one embodiment of a peening machine further includes a vibratory bowl feeder with an opening having a shape the same as an axial cross section of the second workpiece.

At least one embodiment of a peening machine includes a conduit connected to the opening of the vibratory bowl feeder, and an adjusting block, wherein the adjusting block reciprocates to push work pieces exiting the conduit into a conveying groove positioned over a groove of the second disc.

At least one embodiment of a peening machine further includes a hopper connected to a hopper support, wherein the hopper support includes an opening and a shaft adapted to roll in proximity to the opening.

At least one embodiment of a peening machine further includes a delivery disc positioned below the opening to receive a first workpiece in a groove in the delivery disc at a time after the delivery disc rotates.

At least one embodiment of a peening machine further includes a third push rod aligned with a groove in the delivery disc and a groove of the first disc, wherein the third push rod reciprocates to push a first workpiece from a groove in the delivery disc into a groove of the first disc.

At least one embodiment of a peening machine further includes a push-rod guiding block connected with an axial end of the delivery disc, a push-rod guiding through-hole that is provided in the push-rod guiding block in the axial direction to cooperate with the third push rod, and the push-rod guiding through-hole communicates with the delivery grooves of the delivery disc.

At least one embodiment of a peening machine further includes a differential gear connected coaxially with the first and the second disc, wherein the differential disc, the first disc, and the second disc rotate in unison.

At least one embodiment of a peening machine further includes a curved baffle covering the first disc and the second disc.

At least one embodiment of a peening machine includes a first opening in the baffle to guide a second workpiece into a groove of the second disc and a second opening in the baffle to cooperate with the peening needle.

At least one embodiment of a peening machine includes a curved baffle having a first end corresponding to that of the first disc, and a second end of the curved baffle extending beyond the peening hole.

At least one embodiment of a peening machine further includes a receiving chute located below an end of the curved baffle, wherein the receiving chute is connected with a receiving box.

At least one embodiment of a peening machine further includes a third disc having grooves on a periphery of the disc, wherein the grooves extend axially on the periphery, and the grooves are configured to hold a third workpiece. A groove of the third disc is positioned to be aligned with a groove of the first disc and a groove of the second disc, and the first, second, and third discs are coaxially coupled to each other to rotate in unison.

At least one embodiment of a peening machine has the third disc positioned between the first and the second disc, has the first disc holding a plurality of first workpieces that is insertable into a plurality of second workpieces held by the second disc, and has the third disc holding a plurality of third workpieces that is placed on the exterior of the second workpieces.

At least one embodiment of a peening machine further includes a sync mechanism that controls a time of rotation of the first disc and the second disc, and a time of reciprocating the first push rod, the second push rod, and the peening needle.

At least one embodiment of a peening machine includes a sync mechanism that is configured to push the first push rod and the second push rod at the same time toward each other, wherein the first push rod is pushed into a groove of the first disc, the second push rod is pushed into a groove of the second disc. The peening needle is pushed at a time when a first workpiece has been inserted into a second workpiece, and thereafter the first push rod is retracted outside the first disc groove, the second push rod is retracted outside the second disc groove, and the peening needle is retracted outside the second disc.

At least one embodiment of a peening machine is configured so that after the first push rod is retracted outside the first disc groove, the second push rod is retracted outside the second disc groove, and the peening needle is retracted outside the second disc, the sync mechanism is configured to rotate the first disc and the second disc in unison by a distance equal to a groove-to-groove distance. The groove-to-groove distance is an arc distance between the longitudinal axis of a groove of a disc to the longitudinal axis of the immediately adjacent groove of the same disc. Because the first disc has the same diameter of the second disc, the groove-to-groove distance for the first and the second disc is the same.

At least one embodiment of a peening machine is configured so that the peening needle is aligned perpendicular with a groove of the second disc.

At least one embodiment is a pen tip peening machine. The peening machine includes a frame, a pen-tip feeding mechanism, a pen-tip conveying mechanism, an ink-guide-core feeding mechanism, an ink-guide-core conveying mechanism, an assembling mechanism, a peening mechanism and a sync mechanism, each being provided on the frame. The pen-tip conveying mechanism, the ink-guide-core conveying mechanism, the assembling mechanism, and the peening mechanism are each connected with the sync mechanism.

The pen-tip feeding mechanism continuingly feeds metal pen tips into the pen-tip conveying mechanism. The pen-tip conveying mechanism receives and carries the metal pen tips continuously fed by the pen-tip feeding mechanism and then conveys them to the assembling mechanism.

The ink-guide-core feeding mechanism continuingly feeds ink guide cores into the ink-guide-core conveying mechanism. The ink-guide-core conveying mechanism receives and carries the ink guide cores continuously fed by the ink-guide-core feeding mechanism and then conveys them to the assembling mechanism.

The assembling mechanism assembles the metal pen tips conveyed by the pen-tip conveying mechanism and the ink guide cores conveyed by the ink-guide-core conveying mechanism, and at the same time, the peening mechanism peens the metal pen tips that have been connected with the ink guide cores by the assembling mechanism.

The pen-tip feeding mechanism includes a directional vibratory bowl feeder and a motor connected with the vibratory bowl feeder. The feeding opening of the vibratory bowl feeder has a shape the same as the axial cross-section of the metal pen tips. The vibratory bowl feeder feeds the metal pen tips into the pen-tip conveying mechanism via the feeding opening therein.

The pen-tip conveying mechanism includes a conveying conduit, a guiding groove, an inclined conveying groove, and an adjusting block. The conveying conduit, the guiding groove, and the inclined conveying groove are connected to each other and communicate in series. The input end of the conveying conduit receives the metal pen tips fed by the pen-tip feeding mechanism. The conveying conduit carries the metal pen tips in a queue, wherein each of the metal pen tips is aligned with each other with their heads and ends. The output end of the conveying conduit conveys the metal pen tips to the guiding groove.

The adjusting block is positioned next to the guiding groove, and the adjusting block is connected with the sync mechanism. The adjusting block reciprocates to push the metal pen tips in the guiding groove to the input end of the inclined conveying groove. The width of the inclined conveying groove corresponds to the axial length of the metal pen tips, and the depth of the inclined conveying groove corresponds to the maximum diameter of the metal pen tips. The output end of the inclined conveying groove conveys the metal pen tips to the assembling mechanism.

The ink-guide-core feeding mechanism includes an ink-guide-core hopper and a hopper support. The ink-guide-core hopper is provided on the hopper support. An ink-guide-core feeding opening is provided on the hopper support in a vertical direction and communicates with the output opening of the ink-guide-core hopper. The length of the ink-guide-core feeding opening corresponds to the axial length of the ink guide cores. The width of the ink-guide-core feeding opening corresponds to the maximum diameter of the ink guide cores. The ink-guide-core hopper feeds the ink guide cores to the ink-guide-core conveying mechanism via the ink-guide-core feeding opening.

The ink-guide-core conveying mechanism includes a delivery disc and a push rod. A plurality of delivery grooves for receiving the ink guide cores therein is uniformly provided on the outer peripheral wall of the delivery disc, wherein the grooves are aligned along the axial direction. The delivery grooves receive the ink guide cores fed by the ink-guide-core feeding mechanism. The delivery disc is positioned below the ink-guide-core feeding opening so that the ink guide cores drop into the delivery grooves.

The central axis of the push rod is in line with the central axis of each ink guide core individually as the delivery disc rotates. The push rod is connected with the sync mechanism. The push rod reciprocates to push an ink guide core in a delivery groove from the delivery disc into a groove of the ink-guide-core accommodating disc of the assembling mechanism. Then, the delivery disc and the ink-guide-core disc rotate to allow placement of another ink guide core from the delivery disc to the ink-guide-core accommodating disc.

A rolling shaft is provided near the ink-guide-core feeding opening on the hopper support to arrange the ink guide cores uniformly in the ink-guide-core feeding opening and facilitate feeding the delivery disc. The rolling shaft is connected with a second motor via a belt.

A push-rod guiding block is connected with an axial end of the delivery disc. A push-rod guiding through-hole is provided in the push-rod guiding block in the axial direction thereof to cooperate with the push rod. The push-rod guiding through-hole communicates with one of the delivery grooves of the delivery disc.

The assembling mechanism includes a differential mechanism, a pen-tip accommodating disc, an ink-guide-core accommodating disc, a pen-tip push rod, and an ink-guide-core push rod. The differential mechanism includes a differential gear and a differential block cooperating with the differential gear. The differential gear and differential block are configured to rotate the pen-tip accommodating disc and the ink-guide-core accommodating disc for a discrete amount at a time, wherein each discrete amount corresponds to the distance between grooves of the ink-guide-core accommodating disc and the pen-tip accommodating disc.

The differential gear, the pen-tip accommodating disc, and the ink-guide-core accommodating disc are connected coaxially. The differential block is connected with the sync mechanism. The cooperation between the differential block and the differential gear makes the pen-tip accommodating disc and the ink-guide-core accommodating disc rotate simultaneously.

The pen-tip accommodating disc and the ink-guide-core accommodating disc are commonly covered by a curved baffle. A pen-tip guiding opening is provided in the curved baffle. The pen-tip guiding opening guides the metal pen tips conveyed by the pen-tip conveying mechanism into the grooves of the pen-tip accommodating disc.

A plurality of pen-tip accommodating grooves for receiving the metal pen tips are uniformly provided on the outer peripheral wall of the pen-tip accommodating disc. The grooves are positioned along the axial direction. The positions of the pen-tip accommodating grooves correspond to that of the pen-tip guiding opening.

A plurality of ink-guide-core accommodating grooves for receiving the ink guide cores are uniformly provided on the outer peripheral wall of the ink-guide-core accommodating disc. The grooves are positioned along the axial direction. The ink-guide-core accommodating grooves receive the ink guide cores conveyed by the ink-guide-core conveying mechanism. The position of the pen-tip accommodating disc grooves correspond to those of the ink-guide-core accommodating disc grooves by making the diameter of the ink-guide-core accommodating disc substantially the same as the pen-tip accommodating disc.

The pen-tip push rod is located outside the pen-tip accommodating disc. The ink-guide-core push rod is located outside the ink-guide-core accommodating disc. The position of the pen-tip push rod corresponds to that of the ink-guide-core push rod. The central axis of the pen-tip push rod, the central axis of a metal pen tip in a pen-tip accommodating groove, the central axis of the ink-guide-core push rod, and the central axis of an ink guide core in an ink-guide-core accommodating groove are in line. The pen-tip push rod and the ink-guide-core push rod are both connected with the sync mechanism and reciprocate towards each other in order to push a metal pen tip and an ink guide core to assemble together at a time.

The peening mechanism includes a peening needle and a peening hole. The peening hole is provided in the curved baffle and cooperates with the peening needle. The central axis of the peening needle is perpendicular to the central axis of the pen-tip push rod and the central axis of the ink-guide-core push rod. The peening needle is connected with the sync mechanism. The peening hole communicates with a pen-tip accommodating groove individually as the pen-tip accommodating disc rotates.

When the pen-tip push rod and the ink-guide-core push rod reciprocate towards each other in order to push the metal pen tips and the ink guide cores to assemble together, the peening needle also reciprocates through the peening hole in order to peen the metal pen tips connected with the ink guide cores within a pen-tip accommodating disc groove. Then, the sync mechanism causes the pen-tip push rod, the ink-guide-core push rod, and the peening needle to retract to the outside of the pen-tip accommodating disc groove and the ink-guide-core accommodating disc groove. Also, the sync mechanism activates the differential block to cause the differential gear to rotate a discrete amount corresponding to the distance between adjacent disc accommodating grooves. This discrete rotation causes a new unassembled ink guide core in an ink-guide-core accommodating disc groove and a new unassembled pen tip in a pen-tip accommodating disc groove to align with the ink-guide-core push rod and the pen-tip push rod. Then, the sync mechanism repeats the assembling and peening process by activating the ink-guide-core push rod, the pen-tip push rod, and the peening needle.

The position of a first end of the curved baffle corresponds to that of the ink guide cores conveyed by the ink-guide-core conveying mechanism and received by the ink-guide-core accommodating disc, and a second end of the curved baffle extends beyond the peening hole.

A first motor and a speed reducer connected to the first motor are provided below the frame. The speed reducer is connected with the sync mechanism. The adjusting block, the differential block, the push rod, the pen-tip push rod, the ink-guide-core push rod, and the peening needle move synchronistically by way of the sync mechanism.

A pen-tip-seat feeding mechanism and a pen-tip-seat conveying mechanism are further provided on the frame. The pen-tip-seat feeding mechanism includes a vibratory bowl feeder and a second vibration motor connected with the vibratory bowl feeder. The pen-tip-seat conveying mechanism includes a conveying rail. The assembling mechanism further includes a pen-tip-seat accommodating disc. The feeding opening of the vibratory bowl feeder has a shape similar to the axial cross-sectional shape of the pen tip seats. The vibratory bowl feeder feeds the pen tip seats to the conveying rail via the feeding opening. The pen-tip-seat accommodating disc is coaxially connected with the pen-tip accommodating disc. The pen-tip-seat accommodating disc is placed between the pen-tip accommodating disc and the ink-guide-core accommodating disc. A plurality of pen-tip-seat accommodating grooves for receiving the pen tip seats are uniformly provided on the outer peripheral wall of the pen-tip-seat accommodating disc. The grooves are arranged along the axial direction.

The position of the pen-tip-seat accommodating grooves correspond to the output opening of the conveying rail. The positions of the pen-tip-seat accommodating disc grooves correspond to those of the pen-tip accommodating disc grooves and the ink-guide-core accommodating disc grooves by making the diameter of the pen-tip-seat accommodating disc to be the same as the pen-tip accommodating disc and the ink-guide-core accommodating disc. When the pen-tip push rod and the ink-guide-core push rod reciprocate towards each other in order to push a metal pen tip and an ink guide core to be assembled together, the pen tip seat is fitted outside the metal pen tip and the ink guide core simultaneously.

The automatic operation of the peening machine can effectively ensure the uniformity of the depth of the dents by peening, thereby ensuring that the connection between the metal pen tips and the ink guide cores is reliable.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a schematic illustration showing the spatial structure of an embodiment of a peening machine;

FIG. 2 is another schematic illustration showing the spatial structure of an embodiment of a peening machine;

FIG. 3 is an enlarged schematic illustration showing the portion of FIG. 2 labeled “A”:

FIG. 4 is a schematic illustration showing parts of an embodiment of an assembling mechanism;

FIG. 5 is a schematic illustration showing parts of an embodiment of the pen-tip feeding and conveying mechanisms;

FIG. 6 is a schematic illustration of an embodiment of the ink-guide-core feeding mechanism;

FIG. 7 is another schematic illustration of an embodiment of the assembling mechanism; and

FIG. 8 is another schematic illustration of an embodiment of the assembling mechanism.

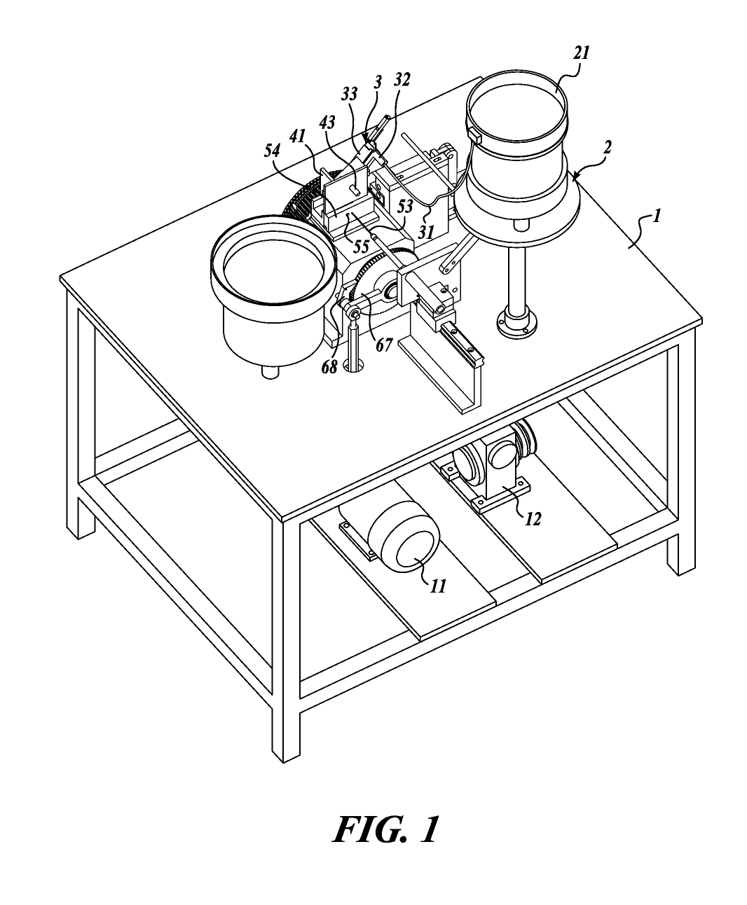

### DETAILED DESCRIPTION

Disclosed herein are peening machines. In various embodiments, a pen tip and an ink guide core are workpieces that can be assembled using the disclosed peening machines. However, the use of pen tips and ink guide cores is merely to illustrate the various embodiments of the peening machines, and is not meant to limit the peening machines exclusively for assembling pen tips and ink guide cores.

As shown in the figures, an embodiment of a peening machine includes a frame 1, a first motor 11 and a speed reducer 12 connected to the first motor 11 which are both below the frame 1, a pen-tip feeding mechanism 2, a pen-tip conveying mechanism 3, an ink-guide-core feeding mechanism 4, an ink-guide-core conveying mechanism 5, an assembling mechanism 6, a peening mechanism 7, and a sync mechanism 85 which are each provided on the frame 1. The speed reducer 12, the pen-tip conveying mechanism 3, the ink-guide-core conveying mechanism 5, the assembling mechanism 6, and the peening mechanism 7 are each connected with the sync mechanism 85.

The pen-tip feeding mechanism 2 continuously feeds metal pen tips into the pen-tip conveying mechanism 3. The pen-tip conveying mechanism 3 receives and carries the metal pen tips continuously fed by the pen-tip feeding mechanism 2, and then conveys them to the assembling mechanism 6. The ink-guide-core feeding mechanism 4 continuously feeds ink guide cores into the ink-guide-core conveying mechanism 5. The ink-guide-core conveying mechanism 5 receives and carries the ink guide cores continuously fed by the ink-guide-core feeding mechanism 4, and then conveys them to the assembling mechanism 6.

The assembling mechanism 6 then assembles the metal pen tips conveyed by the pen-tip conveying mechanism 3 and the ink guide cores conveyed by the ink-guide-core conveying mechanism 5, and at the same time as the ink guide core is assembled to the pen tip, the peening mechanism 7 peens the metal pen tips which have been connected with the ink guide cores. Peening as used herein means to strike a workpiece, such as the metal pen tip with sufficient force to create a dent that secures another workpiece. For example, the peening machines may be used to secure ink guide cores to the metal pen tips.

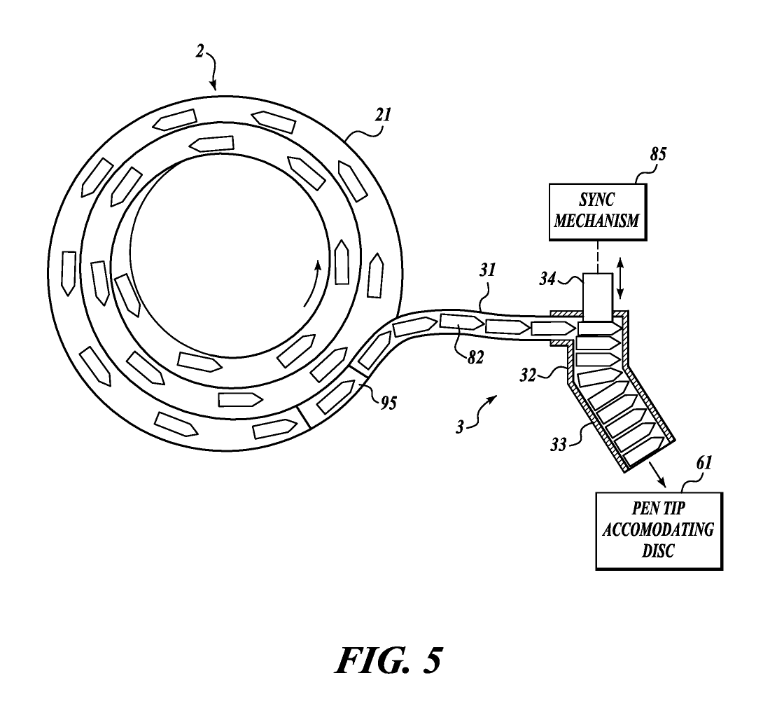

Referring to FIG. 5, in at least one embodiment, the pen-tip feeding mechanism 2 includes a vibratory bowl feeder 21 and a first vibration motor (not shown) connected with the vibratory bowl feeder 21. The feeding opening 95 of the vibratory bowl feeder 21 has a shape similar to the axial cross-section of the metal pen tips 82. The vibratory bowl feeder 21 feeds the metal pen tips 82 into the pen-tip conveying mechanism 3 via the feeding opening 95. The feeding opening 95 is shaped similar to the metal pen tips 82, in order to ensure that the metal pen tips 82 can be fed into the pen-tip conveying mechanism 3 via the feeding opening 95 one by one. Furthermore, the feeding opening 95 has the point of the pen tip forward, and therefore, the pen tips are aligned with the points facing forward in the conveying mechanism 3.

In some embodiments, the pen-tip conveying mechanism 3 includes a conveying conduit 31, a guiding groove 32, an inclined conveying groove 33, and an adjusting block 34. The conveying conduit 31, the guiding groove 32, and the inclined conveying groove 33 are connected and communicate in series. The input end of the conveying conduit 31 receives the metal pen tips 82 fed by the pen-tip feeding mechanism 2. The conveying conduit 31 carries the metal pen tips 82 in a queue, and the metal pen tips are aligned with each other with their heads and ends in an end-to-end fashion with the points facing forward.

The output end of the conveying conduit 31 conveys the metal pen tips to the guiding groove 32. The adjusting block 34 is connected with the sync mechanism 85, and the adjusting block 34 reciprocates to push the metal pen tips in the guiding groove 32 to the input end of the inclined conveying groove 33. The width of the inclined conveying groove 33 corresponds to the axial length of the metal pen tips 82, and the depth of the inclined conveying groove 33 corresponds to the maximum diameter of the metal pen tips 82.

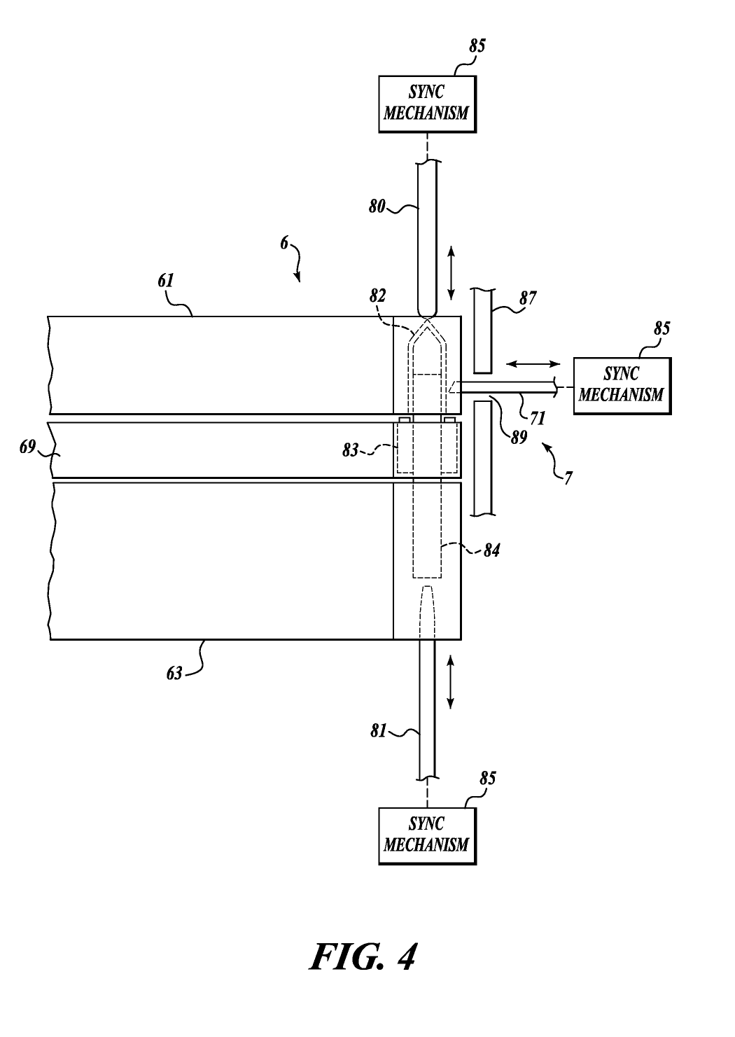

The output end of the inclined conveying groove 33 conveys the metal pen tips 82 to the pen tip accommodating disc 61 of the assembling mechanism shown in FIG. 4. The conveying conduit 31 can droop naturally and the diameter of the conveying conduit 31 is only slightly larger than the maximum diameter of the metal pen tips 82.

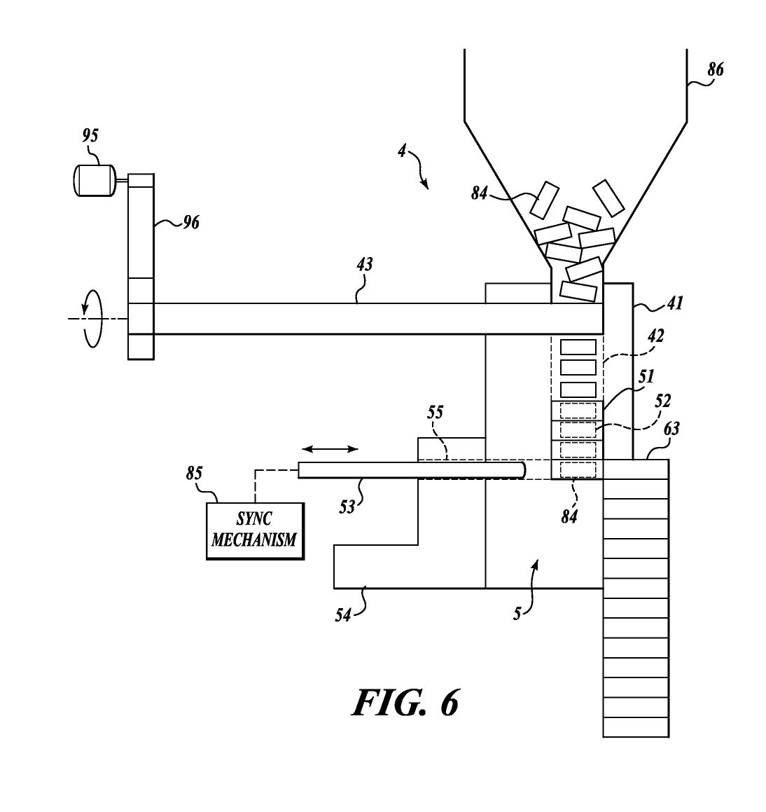

Referring to FIG. 6, in at least one embodiment, the ink-guide-core feeding mechanism 4 includes an ink-guide-core hopper 86 and a hopper support 41. The ink-guide-core hopper 86 is supported by the hopper support 41. An ink-guide-core feeding opening 42 is provided on the hopper support 41 in a vertical direction, and the feeding opening 42 communicates with the output opening of the ink-guide-core hopper 86.

The ink-guide-core feeding opening 42 is in the form of an elongated aperture, the length thereof corresponds approximately to the axial length of the ink guide cores 84, and the width thereof corresponds to the maximum diameter of the ink guide cores 84. The height may vary to hold any number of ink guide cores. The ink guide cores 84 drop by gravity from the ink-guide-core hopper 86 into the ink-guide-core feeding opening 42.

In order to facilitate the ink guide cores 84 within the feeding opening 42 to line up uniformly in the ink-guide-core feeding opening 42, a rolling shaft 43 is provided near the ink-guide-core feeding opening 42 on the hopper support 41. The rolling shaft 43 is connected with a second motor 95 via a belt 96, and the second motor 95 rotates the rolling shaft 43. As a result thereof, the dense ink guide cores 84 near the rolling shaft 43 are lined up on their sides vertically in a single file within the feeding opening 42.

Still referring to FIG. 6, in at least one embodiment, the ink-guide-core conveying mechanism 5 includes a delivery disc 51 and a push rod 53. A plurality of delivery grooves 52 for receiving the ink guide cores 84 are uniformly provided on the outer peripheral wall of the delivery disc 51. The grooves 52 are positioned along the axial direction. The delivery grooves 52 receive the ink guide cores 84 fed by the ink-guide-core feeding mechanism 4.

The delivery disc 51 can be positioned below the feeding opening 42 and the rolling shaft 43 so that the ink-guide-cores 84 drop one at a time into the delivery grooves 52 as the delivery disc 51 rotates. Each increment of rotation may be equal to the groove-to-groove distance of the delivery grooves 51. The groove-to-groove distance is an arc distance between the longitudinal axis of a groove of the delivery disc 51 to the longitudinal axis of the immediately adjacent groove.

The central axis of the push rod 53 is in line with the central axis of one of the ink-guide-core grooves 52 of the delivery disc 51. The push rod 53 is connected with the sync mechanism 85, and the push rod 53 reciprocates to push the ink guide cores 84 in the delivery grooves 52 individually as the delivery disc 51 rotates. The ink-guide-cores 84 are pushed by the push rod 53 from the delivery disc 51 to the ink-guide core accommodating disc 63 of the assembling mechanism 6. A delivery groove 52 is aligned with an ink-guide-core accommodating disc groove 64.

During the assembly process, a push-rod guiding block 54 is connected with an axial end of the delivery disc 51, and a push-rod guiding through-hole 55 is provided in the push-rod guiding block 54 in the axial direction thereof to allow passage of the push rod 53 through the block 54. The push-rod guiding through-hole 55 communicates with one of the delivery grooves 52.

Referring to FIGS. 4, 7, and 8, an embodiment of the assembling mechanism 6 will be described. The assembling mechanism 6 includes a differential mechanism, a first ink-guide-core accommodating disc 63, a second pen-tip accommodating disc 61, a first reciprocating ink-guide-core push rod 81, and a second reciprocating pen-tip push rod 80. The differential mechanism includes a differential gear 67 and a differential block 68 cooperating with the differential gear 67. The differential gear 67, the pen-tip accommodating disc 61, the pen-tip-seat accommodating disc 69, and the ink-guide-core accommodating disc 63 are connected coaxially. The pen-tip accommodating disc 61, the pen-tip-seat accommodating disc 69, and the ink-guide-core accommodating disc 63 can be of the same diameter in size. This allows the grooves in each disc to be in constant alignment during rotation.

The differential block 68 is connected with the sync mechanism 85. The sync mechanism 85 may be a system of linkages, gears, and other mechanisms to provide for the correct timing of reciprocation of various mechanisms, including the pen-tip push rod 80, the ink-guide-core push rod 81, the peening needle 71, the differential block 68, and the differential gear 67. The cooperation between the differential block 68 and the differential gear 67 makes the pen-tip accommodating disc 61 and the ink-guide-core accommodating disc 63 rotate simultaneously.

In particular, the differential gear 67 includes a series of teeth on the outer periphery of the gear. The differential block 68 can include a pawl that engages with a tooth of the differential gear 67 one at a time. The spacing between teeth on the differential gear 67 may correspond to the spacing of the grooves of the ink-guide-core accommodating disc 63, the spacing of grooves of the pen-tip accommodating disc 61, and the spacing of grooves of the pen-tip-seat accommodating disc 69. The differential block 68 therefore allows the differential gear 67 to rotate in increments corresponding to the groove-to-groove distance of the ink-guide-core accommodating disc 63, the pen-tip accommodating disc 61, and the pen-tip-seat accommodating disc 69. The groove-to-groove distance can be defined as an arc distance between the longitudinal axis of a groove of a disc to the longitudinal axis of the immediately adjacent groove of the same disc. Because the first disc has the same diameter of the second disc, the groove-to-groove distance for the first and the second disc is the same. As can be appreciated, this allows a single groove of the ink-guide-core accommodating disc 63, the pen-tip accommodating disc 61, and the pen-tip-seat accommodating disc 69 to be aligned with the respective push rods and peening needle individually. A groove of each disc is aligned with the respective push rod at any one time. Naturally, if the peening machine includes a multiplicity of push rods for any one disc, then, a corresponding number of grooves align with the push rods.

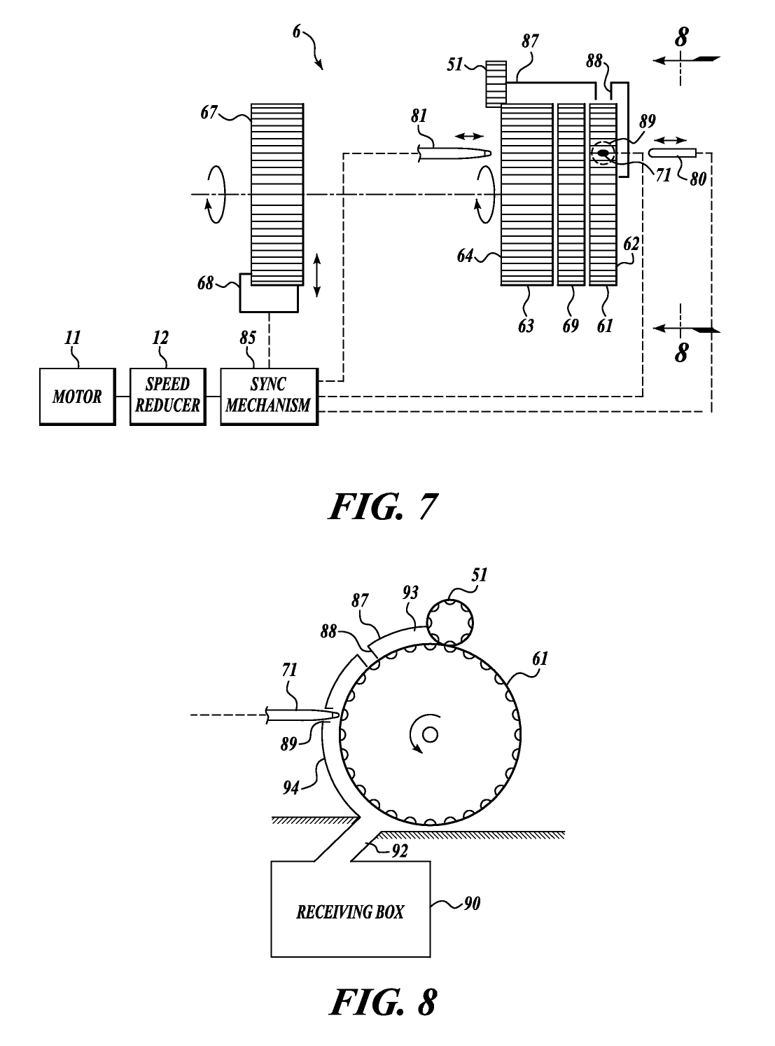

The pen-tip accommodating disc 61 and the ink-guide-core accommodating disc 63 are commonly covered by a curved baffle 87, as shown in FIGS. 7 and 8. A pen-tip guiding opening 88 is provided in the curved baffle 87, in order to guide the metal pen tips 82 conveyed by the pen-tip conveying mechanism 3.

A plurality of pen-tip accommodating grooves 62 for receiving the metal pen tips 82 are uniformly provided on the outer peripheral wall of the pen-tip accommodating disc 61, wherein the grooves 62 are aligned along the axial direction. The pen-tip accommodating grooves 62 can be positioned to individually align with the pen-tip guiding opening 88 in the baffle 87 by rotating the pen-tip accommodating disc 61 with the differential gear 67. In this manner the pen-tip accommodating grooves 62 can be filled with pen tips.

A plurality of ink-guide-core accommodating grooves 64 for receiving the ink guide cores 84 are uniformly provided on the outer peripheral wall of the ink-guide-core accommodating disc 63, wherein the grooves 64 are aligned along the axial direction. The ink-guide-core accommodating grooves 64 can be positioned to individually align to a delivery groove 52 of the delivery disc 52 holding an ink guide core that is opposite to the push rod 53. The push rod 53 pushes an ink guide core from the delivery disc 51 to an ink-guide-core accommodating disc 63 groove. In this manner, the ink-guide-core accommodating grooves 64 can be filled with ink guide cores.

Referring to FIG. 7, in a retracted position, the pen-tip push rod 80 is located outside the pen-tip accommodating disc 61, and in the retracted position, the ink-guide-core push rod 81 is located outside the ink-guide-core accommodating disc 63. The axial position of the pen-tip push rod 80 corresponds to the axial position of the ink-guide-core push rod 81. The central axis of the pen-tip push rod 80, the central axis of a metal pen tip 82 in a pen-tip accommodating groove 62, the central axis of the ink-guide-core push rod 81, and the central axis of an ink-guide-core 84 in an ink-guide-core accommodating groove 64 are in line, as best seen in FIG. 4. The pen-tip push rod 80 and the ink-guide-core push rod 81 both are connected with the sync mechanism 85, and reciprocate towards each other in order to push the metal pen tip 82 and the ink-guide-core 84 together to fit the ink-guide-core 84 in the open end of the pen tip 82.

The peening mechanism 7 includes a peening needle 71 and a peening hole 89. The peening hole 89 is provided in the curved baffle 87 as best shown in FIG. 8, and cooperates with the peening needle 71 by allowing the peening needle 71 to pass through the baffle 87. The central axis of the peening needle 71 is perpendicular to both the central axis of the pen-tip push rod 80 and the central axis of the ink-guide-core push rod 81. The peening needle 71 is also connected with the sync mechanism 85. The peening hole 89 communicates with a pen-tip accommodating groove 62 individually as the accommodating disc 61 is rotated by the differential gear 67, and the position of the peening needle 71 corresponds to the point on the metal pen tip 82 to be peened.

The sync mechanism 85 is in charge of controlling the timing of the differential gear 67, the ink-guide-core accommodating disc 63, the pen-tip accommodating disc 61, the ink-guide-core push rod 81, the pen-tip push rod 80, and the peening needle 71 as follows. After incrementally rotating the ink-guide-core accommodating disc 63 and the pen-tip accommodating disc 61 to position a groove with an ink guide core directly opposite from the ink-guide-core push rod 81, and to position a groove with a pen tip directly opposite from the pen-tip push rod 80, the pen-tip push rod 80 and the ink-guide-core push rod 81 reciprocate toward each other. When the pen-tip push rod 80 and the ink-guide-core push rod 81 reciprocate towards each other, a metal pen tip 82 and an ink-guide-core 84 are assembled by fitting the ink guide core 84 into the hollow pen tip 82.

The peening needle 71 is timed to reciprocate toward the pen tip 82 after the ink guide core 84 is assembled in the pen tip 82. Specifically, the peening needle 71 is timed to strike the pen tip 82 after the ink guide core 84 is assembled in the pen tip 82. The peening needle 71 should have sufficient force to create a dent in the pen tip 82 sufficient to secure the ink guide core therein. The peening needle can make dents of uniform depth. Then, the peening needle 71 is retracted outside the pen-tip accommodating disc, followed by retracting the ink-guide-core push rod 81 outside of the ink-guide-core accommodating disc 63 and groove 64, and retracting the pen-tip push rod 80 outside of the pen-tip accommodating disc 61 and groove 62. Then, the differential gear rotates to position a new ink guide core and pen tip opposite to the ink-guide-core push rod 81 and pen-tip push rod 80.

Referring to FIGS. 7 and 8, the length of the curved baffle 87 may vary as required. In one embodiment, the position of a first end 95 of the curved baffle 87 may correspond to that of the ink guide cores conveyed by the ink-guide-core conveying mechanism 5 including the delivery disc 51, and the position of a second end 94 of the baffle 87 may extend beyond the peening hole 89. Referring to FIG. 8, a receiving chute 92 is provided on the frame 1, and the second end 94 of the baffle 87 is located below the first end 93, so that the peened metal pen tips with the ink guide cores may drop into the receiving chute 92 naturally without being blocked by the curved baffle. The second end 94 of the receiving chute is connected with a receiving box 90.

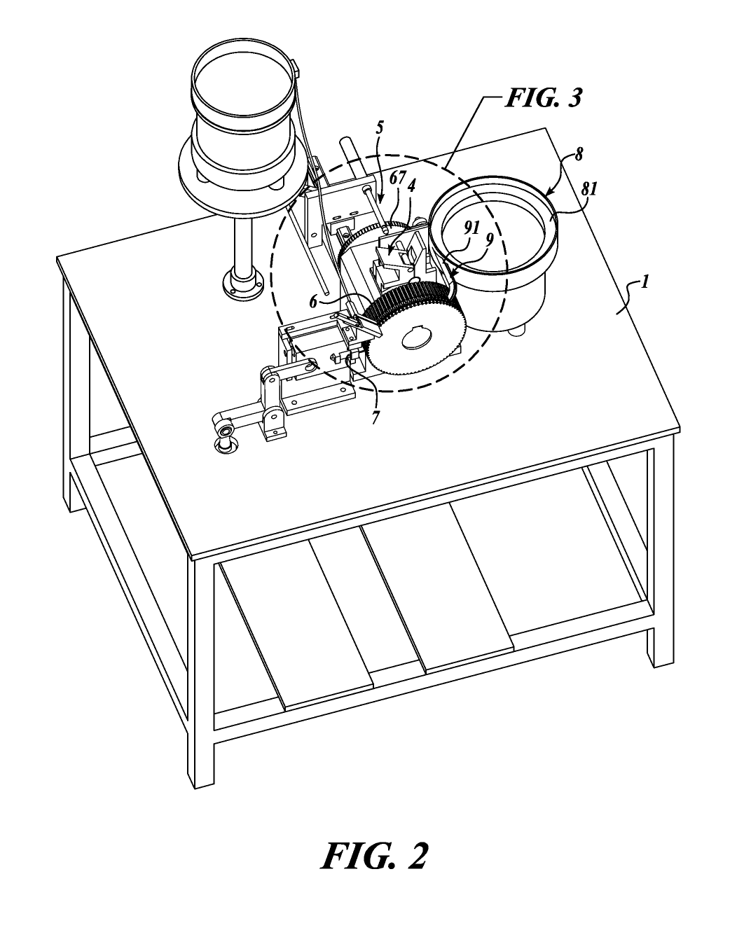

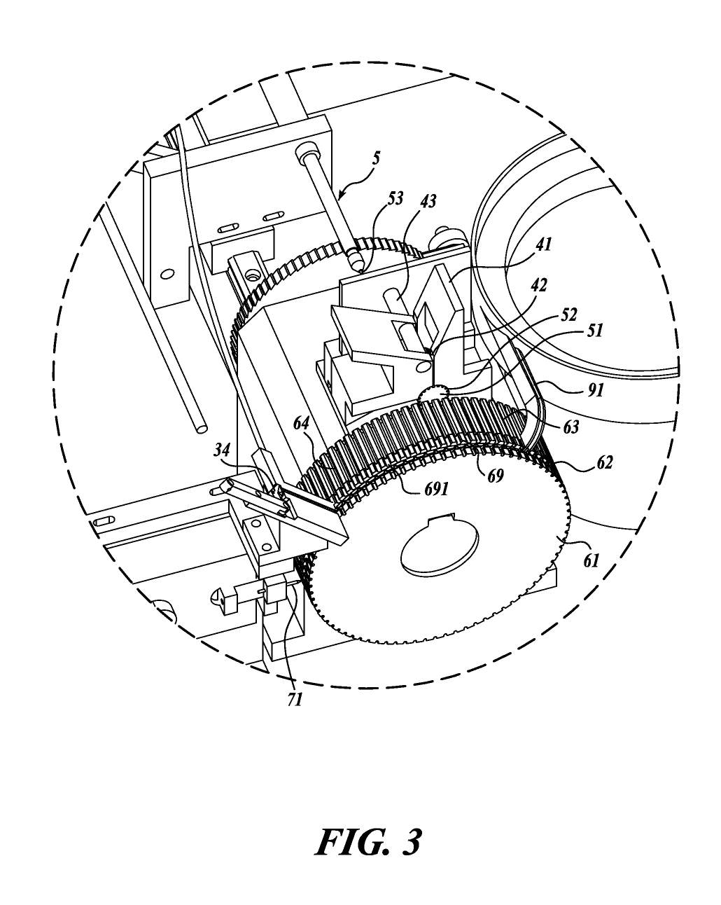

Referring to FIG. 2, a pen-tip-seat feeding mechanism 8 and a pen-tip-seat conveying mechanism 9 may be provided on the frame 1. The pen-tip-seat feeding mechanism 8 includes a vibratory bowl feeder 81 and a second vibration motor connected with the vibratory bowl feeder 81. The pen-tip-seat conveying mechanism 9 includes a conveying rail 91. The feeding opening of the vibratory bowl feeder 81 has a shape similar to the axial cross-sectional shape of the pen tip seats. The vibratory bowl feeder 81 feeds the pen tip seats 83 to the conveying rail 91 via the feeding opening thereof.

Referring to FIG. 4, the assembling mechanism 6 may further include a pen-tip-seat accommodating disc 69 for assembling pen tip seats 83 with the pen tips 82 and ink guide cores 84. The pen-tip-seat accommodating disc 69 is coaxially connected with the pen-tip accommodating disc 61 and the ink-guide-core accommodating disc 63, and the pen-tip-seat accommodating disc 69 is placed between the pen-tip accommodating disc 61 and the ink-guide-core accommodating disc 63. The pen-tip-seat accommodating disc 69 rotates in unison with the pen-tip accommodating disc 61 and the ink-guide-core accommodating disc 63, so as to place a pen tip seat 83 on the pen tip each time a pen tip is assembled with an ink guide core.

A plurality of pen-tip-seat accommodating grooves 691 for receiving the pen tip seats is uniformly provided on the outer peripheral wall of the pen-tip-seat accommodating disc 69, wherein the grooves are aligned along the axial direction. The pen-tip-seat accommodating grooves 691 can be positioned to correspond individually to that of the output opening of the conveying rail 91 by rotating the differential gear 67 a distance equal to the groove-to-groove distance. The positions of the pen-tip-seat accommodating grooves 691 correspond to those of the pen-tip accommodating grooves 62 and the ink-guide-core accommodating grooves 69. Referring to FIG. 4, when the pen-tip push rod 80 and the ink-guide-core push rod 81 reciprocate towards each other in order to push a metal pen tip 82 and an ink guide core 84 together, the pen tip seat 83 is fitted outside the metal pen tip 82 and the ink guide core 84, simultaneously.

While illustrative embodiments have been illustrated and described above, it will be appreciated that various changes can be made therein without departing from the spirit and scope of the invention.

1. A peening machine, comprising:
a first disc having grooves on a periphery of the disc, wherein the grooves extend axially on the periphery and the grooves are configured to hold a first workpiece;
a second disc having grooves on a periphery of the disc, wherein the grooves extend axially on the periphery and the grooves are configured to hold a second workpiece, wherein the first and second discs are coaxially aligned with each other, and wherein a groove of the first disc is positioned to be aligned with a groove of the second disc:
a first reciprocating push rod positioned to be aligned with each groove individually of the first disc as the first disc rotates;
a second reciprocating push rod positioned to be aligned with each groove individually of the second disc as the second disc rotates, wherein the second reciprocating push rod is coaxially aligned with the first reciprocating push rod; and
a reciprocating peening needle positioned perpendicular to the first and second reciprocating pushrods.

2. The peening machine of claim 1, further comprising a first workpiece in a groove of the first disc and a second workpiece in a groove of the second disc, wherein the first workpiece fits within the second workpiece, wherein the first reciprocating push rod is aligned with the first workpiece, and the second reciprocating push rod is aligned with the second workpiece.

3. The peening machine of claim 2, wherein the first reciprocating push rod reciprocates to push the first workpiece toward the second workpiece, the second reciprocating push rod reciprocates to push the second workpiece toward the first workpiece, and the peening needle reciprocates to strike the second workpiece when the first workpiece is within the second workpiece.

4. The peening machine of claim 1, wherein the first workpiece is an ink guide core and the second workpiece is a pen tip.

5. The peening machine of claim 1, further comprising a vibratory bowl feeder with an opening having a shape the same as an axial cross section of the second workpiece.

6. The peening machine of claim 5, further comprising:
a conduit connected to the opening of the vibratory bowl feeder; and
an adjusting block that reciprocates to push workpieces exiting the conduit into a conveying groove positioned over a groove of the second disc.

7. The peening machine of claim 1, further comprising a hopper connected to a hopper support, wherein the hopper support includes an opening and a shaft adapted to roll in proximity to the opening.

8. The peening machine of claim 7, further comprising a delivery disc positioned below the opening to receive a first workpiece in a groove in the delivery disc.

9. The peening machine of claim 8, further comprising a third push rod aligned with a groove in the delivery disc and a groove of the first disc, wherein the third push rod reciprocates to push a first workpiece from a groove in the delivery disc into a groove of the first disc.

10. The peening machine of claim 9, further comprising:
a push-rod guiding block connected with an axial end of the delivery disc; and
a push-rod guiding through-hole provided in the push-rod guiding block in the axial direction to cooperate with the third push rod,
wherein the push-rod guiding through-hole communicates with the delivery grooves of the delivery disc.

11. The peening machine of claim 1, further comprising a differential gear connected coaxially with the first and the second disc, wherein the differential disc, the first disc, and the second disc rotate in unison.

12. The peening machine of claim 1, further comprising a curved baffle covering the first disc and the second disc.

13. The peening machine of claim 1, further comprising a first opening in the baffle to guide a second workpiece into a groove of the second disc and a second opening in the baffle to cooperate with the peening needle.

14. The peening machine of claim 13, wherein a first end of the curved baffle corresponds to that of the first disc, and a second end of the curved baffle extends beyond the peening hole.

15. The peening machine of claim 14, further comprising a receiving chute located below an end of the curved baffle, wherein the receiving chute is connected with a receiving box.

16. The peening machine of claim 1, further comprising a third disc having grooves on a periphery of the disc, wherein the grooves extend axially on the periphery and the grooves are configured to hold a third workpiece, wherein a groove of the third disc is positioned to be aligned with a groove of the first disc and a groove of the second disc, and the first, second, and third discs are coaxially coupled to each other to rotate in unison.

17. The peening machine of claim 16, wherein the third disc is positioned between the first and the second disc, and the first disc holds a plurality of first workpieces that is insertable into a plurality of second workpieces held by the second disc, and the third disc holds a plurality of third workpieces that is placed on the exterior of the second workpieces.

18. The peening machine of claim 1, comprising a sync mechanism that controls a time of rotation of the first disc and the second disc, and a time of reciprocating the first push rod, the second push rod, and the peening needle.

19. The peening machine of claim 18, wherein the sync mechanism is configured to push the first push rod and the second push rod at the same time toward each other, wherein the first push rod is pushed into a groove of the first disc and the second push rod is pushed into a groove of the second disc, wherein the peening needle is pushed at a time when a first workpiece has been inserted into a second workpiece, and thereafter the first push rod is retracted outside the first disc groove, the second push rod is retracted outside the second disc groove, and the peening needle is retracted outside the second disc.

20. The peening machine of claim 19, wherein after the first push rod is retracted outside the first disc groove, the second push rod is retracted outside the second disc groove, and the peening needle is retracted outside the second disc, the sync mechanism is configured to rotate the first disc and the second disc in unison by a distance equal to a groove-to-groove distance.

21. The peening machine of claim 19, wherein the peening needle is aligned perpendicular with a groove of the second disc.
